(19) United States
(12) Patent Application Publication
(10) Pub. No.: US 2013/0092316 A1
(43) Pub. Date: Apr. 18, 2013

(54) Reinforced Liners For Pipelines

(71) Applicants: Rahul Pakal, Dubai (AE); Robert J.T. Appleby, Houston, TX (US)

(72) Inventors: Rahul Pakal, Dubai (AE); Robert J.T. Appleby, Houston, TX (US)

(21) Appl. No.: 13/595,814

(22) Filed: Aug. 27, 2012

Related U.S. Application Data
(60) Provisional application No. 61/547,368, filed on Oct. 14, 2011.

(51) Int. Cl. B29C 47/12; B29C 65/72

(52) U.S. Cl. 156/244.13; 425/461; 264/176.1

(57) ABSTRACT

System and method for producing a pipeline liner for an additional pipeline. An exemplary system comprises a source of material to form a body of the liner and also comprises a source of material to form a reinforcement structure in the liner. The exemplary system additionally comprises a device that simultaneously receives the material to form the body of the liner and the material to form the reinforcement structure in the liner. The device produces the body of the liner with the reinforcement structure interspersed within the body of the liner in a single-step process.

### CROSS-REFERENCE TO RELATED APPLICATION

This application claims the priority benefit of U.S. Provisional Patent Application 61/547,368 filed Oct. 14, 2011 entitled REINFORCED LINERS FOR PIPELINES, the entirety of which is incorporated by reference herein.

### FIELD

The subject innovation relates to providing reinforced liners for existing pipelines. In particular, the subject innovation provides a system and method for producing and deploying a reinforced liner at the location of an existing pipeline.

### BACKGROUND

This section is intended to introduce various aspects of the art, which may be associated with embodiments of the disclosed techniques. This discussion is believed to assist in providing a framework to facilitate a better understanding of particular aspects of the disclosed techniques. Accordingly, it should be understood that this section is to be read in this light, and not necessarily as admissions of prior art.

Most pipelines used for the transportation of oil, gas, water, or mixtures of these fluids, are constructed from carbon steel. Carbon steel is a desirable material due to its availability, low cost relative to other materials, strength, toughness and ability to be welded. However, carbon steels can be corroded by many of the fluids contacting them. Almost all carbon steel pipelines have some level of corrosion of their internal surface and large costs are expended in the monitoring of corrosion, injecting chemicals into the pipeline to inhibit corrosion, and inspection of the pipeline.

Even with these mitigating activities, significant corrosion can occur, causing reduction of the pipe wall thickness, typically in uneven channels or pits. The corrosion can extend along long segments of a pipeline or may be only in localized areas. Furthermore, the corrosion may grow through the pipeline wall resulting in small leaks. These leaks are typically repaired by applying an external clamp around the pipeline. At times the corrosion can be so extensive that external clamps are ineffective and segments of the pipeline are replaced at high cost, often causing long term deferred production of hydrocarbons.

Pipeline liners have been used to provide a barrier against the deleterious effects of internal corrosion on pipelines. The plastic materials of the pipeline liners are placed in direct contact with the transported fluids instead of the steel pipeline. The liners exhibit superior corrosion resistance, yet provide a cost-effective alternative to pipeline replacement or the use of corrosion-resistant alloys. Additionally, remediation of a deteriorated pipeline with a pipeline liner can allow restoration of the full pressure rating of the pipe.

The market for liners is mature to the point that several competing technologies are available. Several types of liners are intended for use in the water-transport and sanitation markets, providing short-length rehabilitation within the pipeline. The vast networks of pipelines in the oil and gas industry have facilitated the development of several long distance pipeline liner options.

Types of long distance pipeline liners include thermoplastic liners and composite liners. Both thermoplastic and composite liners provide corrosion resistance when installed, but the variations in mechanical properties make each of them attractive for particular applications.

Thermoplastic liners, which are the more simple form of pipeline liners, are composed entirely of polymeric, or plastic, material. The most commonly used polymer in pipeline liner applications is High-Density Polyethylene (HDPE), due to its low cost, availability, and range of service conditions. Alternative plastics may also be selected for their enhanced strength or high-temperature service capabilities. These thermoplastic materials have excellent formability and advantageous material properties. Thermoplastic liners are generally not strong enough to withstand long pull lengths or independently withstand the full range of operating pressures prevalent in the hydrocarbon production industry.

Thermoplastic feedstock can easily be extruded into continuous tubular forms. Precise dimensional control allows the liner to conform to the host pipe. The pipeline liner can be reeled for delivery if it has a small diameter, or the liner segments can be fusion welded on-site. Insertion of the liner, or slip-lining, often necessitates that the plastic liner have a temporary size reduction in order to easily traverse within the host pipeline.

Thermoplastic properties allow several options for this size reduction, including roller reduction and folding of the tube into a smaller diameter. In service, the host pipe is still relied upon for pressure containment, but the strength of thermoplastics does allow bridging of small gaps, pits, or pinholes. However, the relatively low range of mechanical strength properties of thermoplastic liners does impose other limitations. The low longitudinal strength limits the pulling length, as the liner will tear under its own weight and the frictional drag that arises during slip-lining It also limits the available host pipe geometries; typical minimum bend radii are on the order of 50 pipe diameters.

Composite liners are another major category of pipeline liners. Composite liners have been developed to expand the range of conditions in which liners may be applied. The cost of composite liners may prohibit their use in remediation projects if the full extent of their properties is not necessary, such as a short pipe that is still capable of pressure containment.

Currently available composite liners are manufactured in a multi-step process in which successive layers are wrapped around a plastic core pipe. In this way, the corrosion resistance of thermoplastics can be combined with the mechanical properties afforded by reinforcing materials such as glass fiber, metallic cables or wires, carbon fiber, ultra-high molecular weight polyethylene (UHMWPE), or nylon. The complexity of these systems necessitates more tooling and results in a greater cost per unit length over plastic liners, but the superior mechanical properties grant the tubing sufficient hoop strength for pressure-containment. In many cases, the host pipe only serves as a conduit for running the composite liner, which then acts as a self-sufficient pipeline. Many composite liners available in the market today were initially designed as stand-alone flexible pipe. The complex fabrication of these composites typically requires that they be manufactured in a facility and then delivered to the installation site on a spool. The size of spools which can be delivered onshore can limit composite liners to small (<6″) diameters.

Like thermoplastic liners, composite pipe liners are installed via slip-lining. The high strength properties allow much longer insertions. The high strength also permits composite liners to negotiate sharper bends in the host pipe. Some known composite liners permit a minimum bend radius as low as nine (9) pipe diameters.

One specific known composite pipeline liners employs an inner HDPE pipe wrapped in various layers of reinforcement. This liner was originally conceived to overcome some of the challenges inherent in the lining process by fabricating the composite in the field. The portable factory removes the length limitations that reeling imposes on length (up to 10 miles), and allows for significantly larger diameter pipelines to be lined. In general, existing liner technologies have not been shown to overcome the issue of severe bends (three to five diameters) in the host pipeline.

### SUMMARY

Exemplary embodiments of the subject innovation relate to systems and methods for producing a pipeline liner for an existing pipeline. An exemplary system comprises a source of material to form a body of the liner. The exemplary system also comprises a source of material to form a reinforcement structure in the liner. The exemplary system additionally comprises a device that simultaneously receives the material to form the body of the liner and the material to form the reinforcement structure in the liner. The device produces the body of the liner with the reinforcement structure interspersed within the body of the liner in a continuous single-step process.

An exemplary method for producing a liner for a pipe according to the subject innovation comprises providing a material to form a body of the liner and providing a material to form a reinforcement structure in the liner. The material to form the body of the liner and the material to form the reinforcement structure in the liner are simultaneously combined, so that the body of the liner is produced with the reinforcement structure interspersed within the body of the liner.

One example of the subject innovation includes a method for lining an existing pipe with a liner. The method comprises providing a material to form a body of the liner and providing a material to form a reinforcement structure in the liner. In a single-step process, the material to form the body of the liner and the material to form the reinforcement structure in the liner are simultaneously combined, so that the body of the liner is produced with the reinforcement structure interspersed within the body of the liner. As the liner is produced, it is pulled through the existing pipe.

### DESCRIPTION OF THE DRAWINGS

Advantages of the subject innovation may become apparent upon reviewing the following detailed description and drawings of non-limiting examples of embodiments in which:

FIG. 1 is a diagram showing a system of providing a liner for a pipe according to the subject innovation;

FIG. 2 is a diagram showing a system for providing a liner for a pipe using fiber pultrusion according to the subject innovation;

FIG. 3 is a diagram showing a system for providing a liner for a pipe using long-fiber co-extrusion according to the subject innovation;

FIG. 4 is a diagram showing a system for providing a liner for a pipe using tape pultrusion according to the subject innovation; and

FIG. 5 is a cross-section of a pipeline liner produced via tape pultrusion according to the subject innovation.

### DETAILED DESCRIPTION

In the following detailed description section, specific embodiments are described in connection with preferred embodiments. However, to the extent that the following description is specific to a particular embodiment or a particular use, this is intended to be for exemplary purposes only and simply provides a description of the exemplary embodiments. Accordingly, the subject innovation is not limited to embodiments described herein, but rather, it includes all alternatives, modifications, and equivalents falling within the spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent.

The subject innovation relates to a system and method for inserting a polymeric liner into an existing pipeline to separate corrosive fluid running through the inside of the pipeline from the inside wall of the pipeline in order to prevent or reduce further corrosion. The liner may bridge small holes in the steel pipeline wall, thus stopping small leaks. In addition, a liner according to the subject innovation may be installed in older pipelines that have corrosion damage, or in new pipelines to prevent corrosion damage. It is desirable for the pipeline to have sufficient structural strength to support the lining.

There are many possible applications for liners that necessitate properties beyond that of thermoplastics but do not demand the elevated properties or cost of composites. A simplified form of composite that provides the service characteristics of a thermoplastic with the installation options possible with current composites would greatly expand the opportunities for liners in the marketplace. Reinforcing materials may be used to attain greater pull lengths and to overcome tight bends in the host pipe that restrict current liner installation. In service, however, a liner according to the subject innovation has properties similar to a thermoplastic by providing a barrier against further corrosive attack on the host pipe. In this way, a liner according to the subject innovation may improve performance/cost ratio relative to known technologies. Further cost-savings may be available by incorporating matrix material and reinforcement material into a liner in a single manufacturing step, thus reducing the necessary tooling, footprint, and manpower.

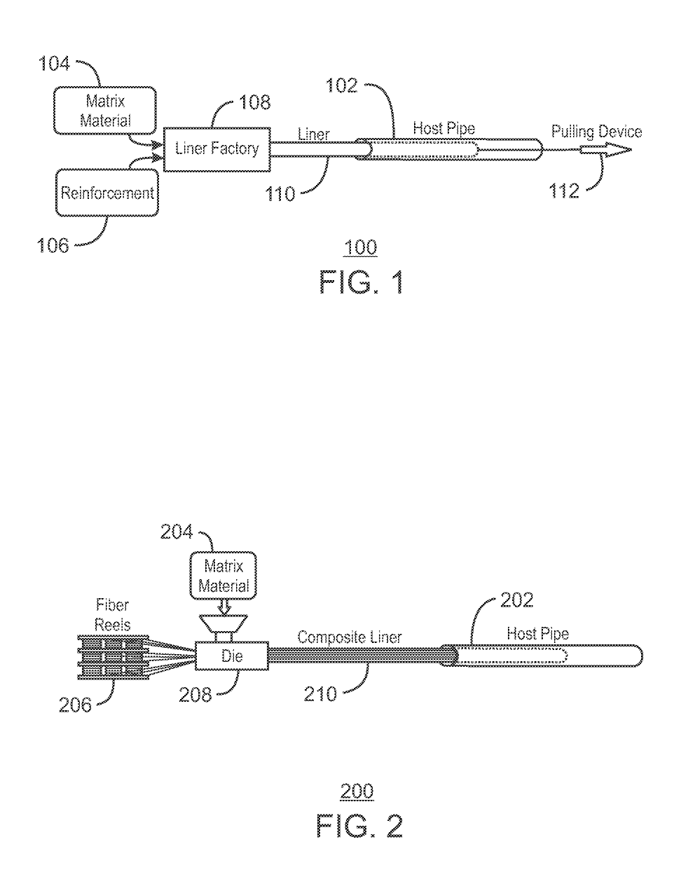

FIG. 1 is a diagram showing a system 100 of providing a liner for a host pipe 102 according to the subject innovation. A matrix material source 104 provides matrix material to the liner manufacturing equipment, herein referred to as the liner factory 108. Simultaneously, a reinforcement material source 106 provides reinforcement material to the liner factory 108. As explained herein, the liner factory 108 combines matrix material from the matrix material source 104 with reinforcement material from the reinforcement material source 106 to produce a pipeline liner 110.

As explained herein, the pipeline liner 110 may comprise a body portion produced from the matrix material. The pipeline liner 110 additionally comprises a reinforcing structure produced from the reinforcement material. The liner factory 108 is an example of a device that simultaneously receives the material to form the body portion of the liner (the matrix material) and the material to form the reinforcement structure (the reinforcement material) in the liner. The liner factory 108 then produces the body of the liner with the reinforcement structure interspersed within the body of the liner in a continuous single-step process.

In the example shown in FIG. 1, the pipeline liner 110 may be pulled through an existing host pipe 102 by a pulling device 112 as it is produced. In this manner, the matrix material and the reinforcement material needed to produce the pipeline liner 110 may be efficiently transported to the site of the host pipe 102. Moreover, the pipeline liner 110 may be produced in one manufacturing operation at the site of the host pipe 102.

According to the subject innovation, the pipeline liner 110 provides a cost-effective lining for a long-distance pipeline for the purpose of remediation. An exemplary embodiment combines desirable attributes of thermoplastic and composite liners described herein in order to maximize the longitudinal strength of the liner with a single-step manufacturing process. The pipeline liner 110, which is a composite liner, is produced in a manner similar to a plastic pipe or liner, but reinforcement material is simultaneously included in the same process.

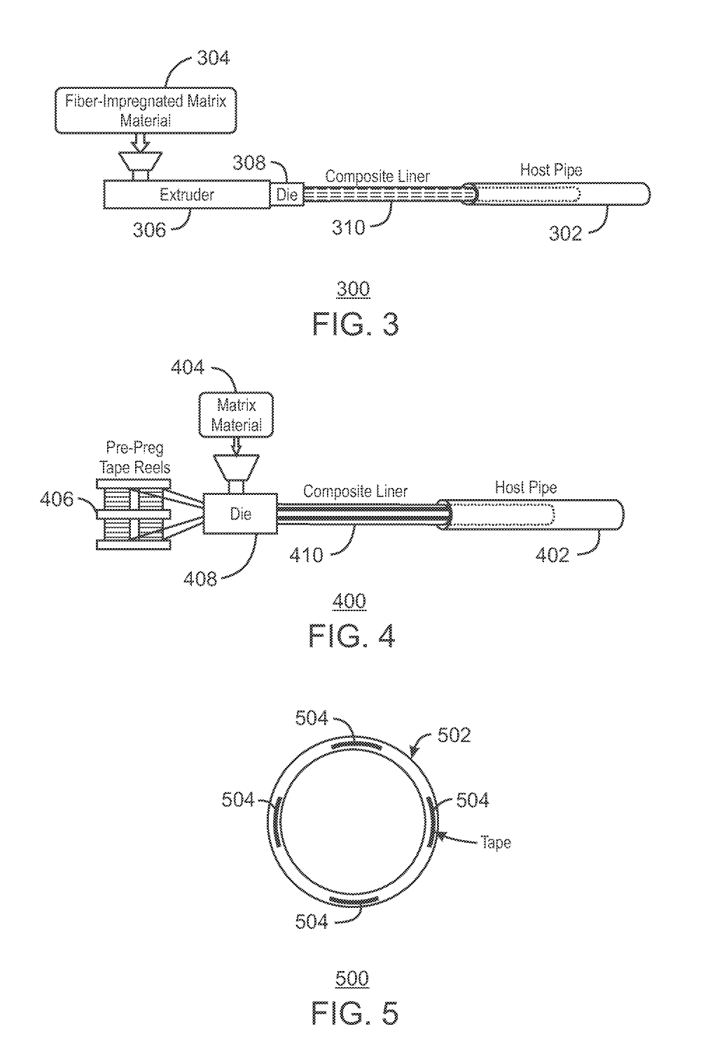

FIGS. 2-4 provide specific examples of different fabrication techniques that may be employed according to the subject innovation. The examples shown in FIG. 2 (pultrusion) and FIG. 3 (co-extrusion) promote longitudinal orientation for the reinforcing material, which maximizes its contribution to the tensile strength of the liner. Efficient use of the reinforcing material is an important aspect the design of the pipeline liner of the subject innovation, as the cost of reinforcing material can be several times greater than the composite matrix material. The large increase in tensile strength caused by reinforcing materials permits longer pulling distances, as the pipeline liner can now withstand more frictional drag during slip-lining installation. One example of reinforcing material that may be used is fiber. Examples of material types that may be used to provide fiber reinforcement according to the subject innovation include glass fiber, metallic cables or wires, carbon fiber, ultra-high molecular weight polyethylene (UHMWPE), and nylon, among others. However, pre-preg tapes or strips composed in part by these materials could also be used to confer axial strength during installation, as described herein with reference to the example shown in FIG. 4.

A pipeline liner according to the subject innovation may provide advantages relative to known pipeline liners. First, the longer pulling distance reduces the number of incursions that are typically made when remediating long-distance pipelines. Because greater distances can now be lined in a single slip-lining operation, more pipelines than ever before could be amenable to remediation by lining. For instance, some pipelines can no longer be accessed easily because of structures and/or populations that have since accumulated over them. The improved tensile strength of the pipeline liner of the subject innovation would increase the range of pipeline geometries open to slip-lining, since a stronger liner could more easily negotiate pipelines with bends in their length.

A single-step manufacturing process according to the subject innovation also improves the portability of the process over known composite-type pipeline liners. The use of a portable factory as described herein simplifies the case of in-field fabrication. Space considerations for a long-distance slip-lining operation become difficult if the entire length of liner is to be delivered in whole to the work-site. In-field fabrication according to the subject innovation allows for relatively efficient delivery of the raw materials and the factory itself to the work-site, without transporting a completed pipeline liner to the work-site. The continuous manufacturing method also eliminates the necessity of a joining process to produce the long-distance liner.

Like the thermoplastic liners described herein, a pipeline liner according to the subject innovation may provide the hoop strength of the host pipeline during service by assuming a tight fit along the inner pipe surface. The use of reinforcements aligned circumferentially in order to impart hoop strength to the liner can therefore be omitted, reducing the overall material cost. However, if the integrity of the host pipeline could not be assured, the subject innovation permits the addition of spirally-wound reinforcements in a subsequent manufacturing step. The pipeline liner would then be lent a pressure-carrying capacity.

FIG. 2 is a diagram showing a system 200 for providing a liner for a pipe using fiber pultrusion according to the subject innovation. A matrix material source 204 provides matrix material to a forming die 208. Simultaneously, a number of fiber reels 206 provide fiber reinforcement material to the die 208. As explained herein, the die 208 combines matrix material from the matrix material source 204 with fiber reinforcement material from the fiber reels 206 using a process of fiber pultrusion to produce a pipeline liner 210. The pipeline liner 210 may then be deployed within a host pipe 202, as fully set forth herein.

Carbon fibers are examples of strong fibers that are readily available for use in the system 200. Carbon fibers possess tensile strengths on the order of giga-pascals, which is several orders of magnitude greater than the strength of thermoplastic materials. An exemplary method for using carbon fibers efficiently is to make them continuous along the length of the liner. The pultrusion manufacturing process performed by the system 200 is capable of delivering a tubular composite with continuous fibers. In an exemplary process of pultrusion, fibers are unwound from the fiber reels 206 and passed through a container of liquefied matrix material. The wetted fibers then pass through the forming die 208, which defines the shape of the resultant composite material. Since the fibers are being pulled, they will tend to maintain a longitudinal orientation. The longitudinal orientation of the fibers maximizes their contribution to axial strength, potentially reducing the overall amount of fibers needed and further reducing the material costs.

FIG. 3 is a diagram showing a system 300 for providing a liner for a pipe using long-fiber thermoplastic extrusion (LFT) according to the subject innovation. LFT provides a relatively large degree of control over the extrusion process. In this manner, fibers emerge from a die in significantly greater lengths. The tensile strength of the resulting pipeline liner is thus considerably improved.

In the example shown in FIG. 3, a fiber-impregnated matrix material source 304 is delivered to an extruder 306. The extruder 306 delivers processed fiber-impregnated matrix material to a die 308. The die 308 then produces a composite liner 310 that includes fiber reinforcement. The composite liner 310 may be deployed into a host pipe 302 as explained herein.

FIG. 4 is a diagram showing a system 400 for providing a liner for a pipe using tape pultrusion according to the subject innovation. A matrix material source 404 provides matrix material to a die 408. Simultaneously, a number of pre-impregnated tape reels 406 provide reinforcement material to the die 408. As explained herein, the die 408 combines matrix material from the matrix material source 404 with reinforcement material from the pre-impregnated tape reels 406 using a process of tape pultrusion to produce a composite pipeline liner 410. The pipeline liner 410 may then be deployed within a host pipe 402, as fully set forth herein.

FIG. 5 is a cross-section of a pipeline liner 500 produced via tape pultrusion according to the subject innovation. The pipeline liner 500 comprises a body portion 502 of matrix material. At various points around the circumference of the body portion 502, reinforcement structures 504 in the form of tape elements are deployed. The reinforcement structures 504 provide axial strength for the body portion 502.

Unlike known liner technologies, a pipeline liner according to the subject innovation may provide the ability to remediate relatively long-distance pipelines from a single access point using low-cost materials. Such an improvement is useful in the energy industry, which employs pipeline assets of significantly greater scale than, for example, the utility industry.

In addition, a manufacturing process according to the subject innovation may provide the ability to produce a tubular composite with a thermoplastic matrix and longitudinal reinforcement. With respect to composite materials, the amount of strengthening provided by a reinforcing material is a function of the length of the reinforcing material. An exemplary manufacturing process facilitates the inclusion of reinforcing material in sufficiently long lengths to make hydrocarbon industry pipeline remediation feasible. Moreover, the manufacturing process does not break the fibers up into pieces so small that they provide relatively little in the way of strength reinforcement.

The subject innovation may be used to provide a pipeline liner having a relatively high ratio of desirable qualities to cost. Some techniques to maximize this ratio include the use of the most effective materials in the most efficient quantities. Thermoplastic matrix materials are available in many forms, with a variety of costs and strength properties. Because an exemplary pipeline liner according to the subject innovation relies on the host pipeline for pressure containment, it may not be necessary to select a high-strength matrix that would incur greater costs. A simple and inexpensive thermoplastic like HDPE may be sufficient. Moreover, HDPE is known to be capable of maintaining pressure over small gaps or pores in the host pipeline. HDPE further serves as an excellent barrier to prevent internal pipeline corrosion.

Exemplary embodiments of the subject innovation combine a continuous manufacturing process with compatible materials. When a pipeline liner according to the subject innovation is manufactured in one continuous process, the materials used in the pipeline liner are desirably compatible with the manufacturing technique and able to provide the necessary properties for installation and operation. Reinforcing material such as fibers are desirably selected to withstand the pulling forces for installation, while the thermoplastic matrix is chosen to serve as a sufficient barrier to corrosive fluids.

The subject innovation may be susceptible to various modifications and alternative forms, and the exemplary embodiments discussed above have been shown only by way of example. However, the subject innovation is not intended to be limited to the particular embodiments disclosed herein. Indeed, the present techniques include all alternatives, modifications, and equivalents falling within the spirit and scope of the appended claims.

What is claimed is:

1. A system for producing a liner for a pipe, the system comprising:
a source of material to form a body of the liner;
a source of material to form a reinforcement structure in the liner; and
a device that simultaneously receives the material to form the body of the liner and the material to form the reinforcement structure in the liner and produces the body of the liner with the reinforcement structure interspersed within the body of the liner in a single-step process.

2. The system recited in claim 1, wherein the material to form the body of the liner comprises a matrix material.

3. The system recited in claim 1, wherein the material to form the reinforcement structure comprises a fiber-type material.

4. The system recited in claim 1, wherein the material to form the reinforcement structure comprises glass, carbon, or high-strength polymer fiber.

5. The system recited in claim 1, wherein the material to form the reinforcement structure comprises metallic cable or wire.

6. The system recited in claim 1, wherein the material to form the reinforcement structure comprises high-strength tapes or strips.

7. The system recited in claim 1, wherein the material to form the body of the liner and the material to form the reinforcement structure in the liner are incorporated into a fiber-impregnated matrix material.

8. The system recited in claim 1, wherein the device that simultaneously receives the material to form the body of the liner and the material to form the reinforcement structure in the liner comprises a liner factory.

9. The system recited in claim 1, wherein the device that simultaneously receives the material to form the body of the liner and the material to form the reinforcement structure in the liner comprises a pultruder.

10. The system recited in claim 1, wherein the device that simultaneously receives the material to form the body of the liner and the material to form the reinforcement structure in the liner comprises an extruder and a die.

11. The system recited in claim 1, wherein the single-step process comprises a fiber pultrusion process.

12. The system recited in claim 1, wherein the single-step process comprises a tape pultrusion process.

13. The system recited in claim 1, wherein the single-step process comprises a fiber extrusion process.

14. The system recited in claim 1, wherein the reinforcement structure provides longitudinal reinforcement and increased axial strength of the liner.

15. A method for producing a liner for a pipe, the method comprising:
providing a material to form a body of the liner;
providing a material to form a reinforcement structure in the liner; and
simultaneously combining the material to form the body of the liner and the material to form the reinforcement structure in the liner, so that the body of the liner is produced with the reinforcement structure interspersed within the body of the liner.

16. The method recited in claim 15, wherein simultaneously combining the material to form the body of the liner and the material to form the reinforcement structure in the liner comprises a fiber pultrusion process.

17. The method recited in claim 15, wherein simultaneously combining the material to form the body of the liner and the material to form the reinforcement structure in the liner comprises a tape pultrusion process.

18. The method recited in claim 15, wherein simultaneously combining the material to form the body of the liner and the material to form the reinforcement structure in the liner comprises an extrusion process.

19. The method recited in claim 15, wherein the reinforcement structure provides longitudinal reinforcement and increased axial strength of the liner.

20. A method for lining an existing pipe with a liner, the method comprising:
providing a material to form a body of the liner;
providing a material to form a reinforcement structure in the liner;
simultaneously combining in a single-step process the material to form the body of the liner and the material to form the reinforcement structure in the liner, so that the body of the liner is produced with the reinforcement structure interspersed within the body of the liner; and
pulling the liner, as it is produced, through the existing pipe.

21. The method recited in claim 20, wherein the liner is horizontally or vertically displaced in a loop or bends prior to insertion into the existing pipe, in order to allow different liner manufacturing and liner insertion speeds.
